(19) United States
(12) Patent Application Publication
(10) Pub. No.: US 2006/0104331 A1
(43) Pub. Date: May 18, 2006

(54) Device for measuring, monitoring and/or controlling a temperature

(76) Inventors: David Dreher, Neftenbach (CH); Christopherus Bader, Neftenbach (CH)

Correspondence Address: BACHMAN & LAPOINTE, P.C., 900 CHAPEL STREET, SUITE 1201, NEW HAVEN, CT, 06510, US

(21) Appl. No.: 10/540,714

(22) PCT Filed: Dec. 11, 2003
(86) PCT No.: PCT/EP03/14092

§ 371 Date: Sep. 2, 2005

(51) Int. Cl. G01K 1/00

(52) U.S. Cl. 374/208

(57) ABSTRACT

A device for measuring, monitoring and/or controlling a temperature, in particular the temperature of the wall of an injection mold with the aid of a measuring element which passes a detector body through a corresponding orifice at least to the external walls thereof. The measuring element is blocked in the detector body and/or in a crimping bush which is disposed prior to said detector body.

The invention relates to an apparatus for measurement, monitoring and/or regulation of a temperature in particular the temperature of the mold wall of an injection mold, by means of at least one measurement element which pulls through a sensor body in a corresponding hole at least as far as its outer walls.

### PRIOR ART

The measurement, monitoring and regulation of a temperature is important and necessary in many manufacturing areas. The monitoring of the temperature of an injection mold, as is described, for example, in DE 101 14 228 A1, is mentioned merely by way of example. The entire injection process is controlled by means of appropriate thermal measurement elements which determine the mold wall temperature. For this reason, these thermal measurement elements are extremely important.

In known thermal measurement elements, the corresponding supply line is located loosely in a sensor body, with the measurement elements projecting out of the end surface of the sensor body, where they are fixed by means of a weld droplet or the like. This results in the end surface being irregular by virtue of the layer of the weld bulge between the medium to be measured and the measurement element, which leads to considerable sensor inaccuracies.

Furthermore, a thick mounting sleeve is provided on the equalizing line, and forms the transition from a metal tube between the mounting sleeve and the sensor body to a flexible cable. This mounting sleeve is also used as strain relief for the measurement elements in the sensor body. However, it has the disadvantage that a space must be left free for it in the injection mold, and this represents a weak point in the mold.

### OBJECT

The present invention is based on the object of providing an apparatus and a method for production of this apparatus, by which means these disadvantages are avoided. The measurement elements should be securely fixed without the accuracy being adversely affected. Furthermore, the apparatus should be kept as thin as possible in order to weaken the injection mold as little as possible (cable duct).

### ACHIEVEMENT OF THE OBJECT

In order to achieve this object, the measurement element is firmly clamped in the sensor body and/or in a crimping sleeve in front of the sensor body.

This ensures that the measurement elements remain in their desired position without having to be fixed by spot welds. The crimping provides strain relief for the measurement elements. There is no need for a thick mounting sleeve, so that the entire equalizing line can be kept thinner.

The idea of the invention covers the measurement elements being fixed by crimping in the sensor body and/or in corresponding holes. The crimping process is then carried out as close as possible to the tip of the sensor body, so that the measurement elements cannot escape from their desired usage position.

In some cases, it is even sufficient for only the equalizing line to be fixed in the crimping sleeve. However, the measurement elements could then still move back in the holes in the sensor body if, for example, pressure were exerted from the end surface. In one preferred exemplary embodiment, both the sensor body and the crimping sleeve are therefore crimped.

Should it be possible to insert the measurement elements into the holes in the sensor body such that their end surfaces are located exactly on the same plane as the end surface of the sensor body, then it would be sufficient for them just to be inserted into the holes, and for the crimping process then to be carried out. However, in order to achieve exact positioning of the end surfaces of the measurement elements on the same plane as the end surface of the sensor body, it has been found to be advantageous to allow the measurement elements to project slightly beyond the end surface of the sensor body, and to fix them there by a weld or solder droplet. The crimping process can now be carried out, after which the weld or solder droplet is ground off together with the ends of the measurement elements, thus ensuring that the end surfaces of the measurement elements are finally located on the same plane as the end surface of the sensor body. However, in this case, it is not absolutely essential to fix the measurement elements. Separate protection is therefore also desirable to ensure that the measurement element projects out of the hole, possibly being covered with a weld of solder droplet, and being ground off.

In one preferred exemplary embodiment, the equalizing line has external insulation composed of glass silk/Kapton. This external insulation insulates the equalizing line from the hot injection mold.

In addition, the invention provides for an extraction thread to be adjacent to the crimping sleeve, so that the sensor body can easily be pulled up, for example, from a hole in the injection mold by means of an appropriate tool.

### DESCRIPTION OF THE FIGURES

Further advantages, features and details of the invention will become evident from the following description of preferred exemplary embodiments and from the drawing, in which:

FIG. 1 shows a plan view of an apparatus according to the invention for monitoring a temperature;

FIG. 2 shows an enlarged cross section through the front area of the apparatus shown in FIG. 1;

FIG. 3 shows a cross section, once again enlarged, from the area of the tip of the apparatus shown in FIG. 1, in a preliminary stage in its production.

FIG. 4 shows a schematically illustrated cross section through a further exemplary embodiment of a tip of an apparatus as shown in FIG. 1.

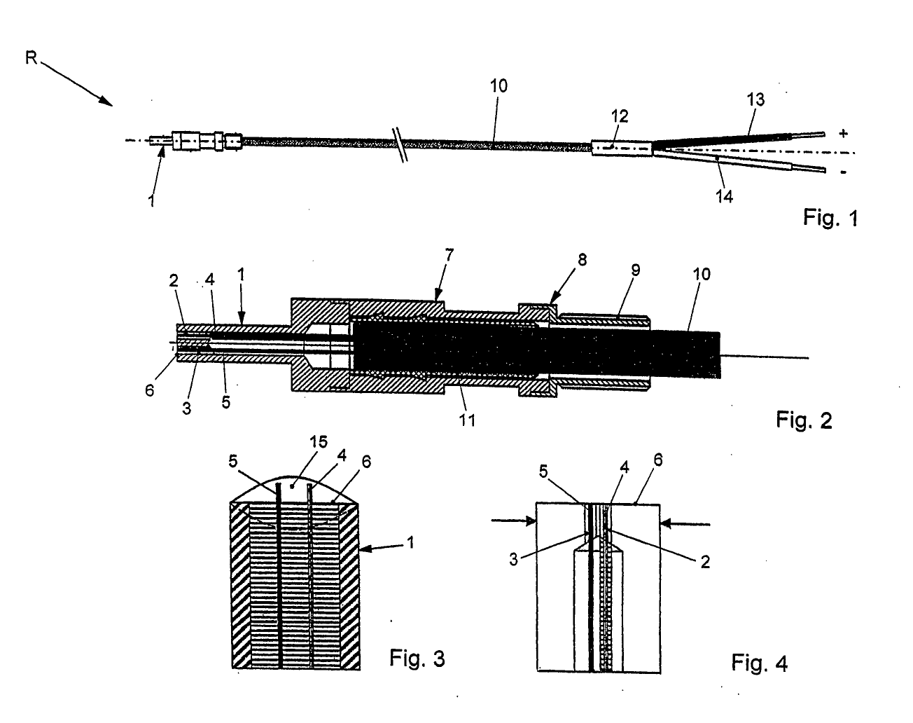

An apparatus R according to the invention for measurement of the temperature, for example of the mold wall of an injection mold, has, as can be seen in FIGS. 1 and 2, a sensor body 1 in which two longitudinal holes 2 and 3 are provided. A respective measurement element 4 and 5 is provided in each longitudinal hole 2 and 3, and the tips of these measurement elements 4 and 5 are located on the same plane as the end surface 6 of the sensor body 1.

The sensor body 1 is adjacent to a crimping sleeve 7, onto which an extraction piece 8 with an extraction thread 9 is plugged. The crimping sleeve 7 and the extraction piece 8 surround an equalizing line 10, with another insulating sleeve 11 being provided between the equalizing line 10 and the crimping sleeve 7.

The two measurement elements 4 and 5 project out of the equalizing line 10 and engage in the longitudinal holes 2 and 3.

At the other end, the equalizing line 10 ends in a sleeve 12, where it branches into the connecting lines 13 and 14.

The method of production of the apparatus according to the invention will be described in more detail in the following text with reference, inter alia, to FIGS. 3 and 4 as well.

The extraction piece 8, the crimping sleeve 7 and the sensor body 1 are pushed onto the free end of the equalizing line 10, beyond the sleeve 12. In the process, care must be taken to ensure that the measurement elements 4 and 5 find their longitudinal holes 2 and 3. In this case, as shown in FIG. 3, the measurement elements 4 and 5 may project out of the end surface 6 of the sensor body.

A defined spot weld 15 is now applied, with wide tolerances, to the end surface 6. After this, this spot weld 15 is ground off or the weld bulge is ground off to the level of the planar end surface 6.

In contrast, FIG. 4 indicates that the measurement elements 4 and 5 end on the same plane as the end surface 6. After this, the front area, as indicated by the arrows, is compressed or crimped, thus providing the capability for a clearly defined temperature measurement. Even better than in the case of welding, the measurement elements 4 and 5 are fixed in position in the longitudinal holes 2 and 3 by the crimping process, so that they cannot be pulled out of the longitudinal holes 2 and 3. This method allows subsequent machining of the sensor front by the user in order to match this to the surface of the cavity.

In one preferred exemplary embodiment, the crimping sleeve 7 is also crimped, resulting in the equalizing line 10, or its front area, being fixed in the crimping sleeve 7. This is also used for strain relief for the equalizing line 10. The crimping sleeve 7 is, of course, not crimped until the crimping sleeve 7 has been plugged onto the sensor body 1.

The extraction piece 8 can be connected to the crimping sleeve 7 even in advance, for example by welding or adhesive bonding, although a threaded connection could also be provided. An appropriate tool can be screwed onto the extraction thread 9 of the extraction piece 8 in order to pull the crimping sleeve 7 and the sensor body 1 out of the usage position in the mold wall of an injection mold.

### LIST OF ITEM NUMBERS

| | |
|---|---|
| 1 | Sensor body |
| 2 | Longitudinal hole |
| 3 | Longitudinal hole |
| 4 | Measurement element |
| 5 | Measurement element |
| 6 | End surface |
| 7 | Crimping sleeve |
| 8 | Extraction piece |
| 9 | Extraction thread |
| 10 | Equalizing line |
| 11 | Insulating sleeve |
| 12 | Sleeve |
| 13 | Connecting line |
| 14 | Connecting line |
| 15 | Spot weld |
| 16 | |
| 17 | |
| 18 | |
| 19 | |
| 20 | |
| 21 | |
| 22 | |
| 23 | |
| 24 | |
| 25 | |
| 26 | |
| 27 | |
| 28 | |
| 29 | |
| 30 | |
| 31 | |
| 32 | |
| 33 | |
| 34 | |
| 35 | |
| 36 | |
| 37 | |
| 38 | |
| 39 | |
| 40 | |
| 41 | |
| 42 | |
| 43 | |
| 44 | |
| 45 | |
| 46 | |
| 47 | |
| 48 | |
| 49 | |
| 50 | |
| 51 | |
| 52 | |
| 53 | |
| 54 | |
| 55 | |
| 56 | |
| 57 | |
| 58 | |
| 59 | |
| 60 | |
| 61 | |
| 62 | |
| 63 | |
| 64 | |
| 65 | |
| 66 | |
| 67 | |
| 68 | |
| 69 | |
| 70 | |
| 71 | |
| 72 | |
| 73 | |
| 74 | |
| 75 | |
| 76 | |
| 77 | |
| 78 | |
| 79 | |
| R | Apparatus |

1-9. (canceled)

10. An apparatus for the measurement of the temperature of a mold wall of an injection mold comprises a sensor body having an orifice which terminates at an external wall of the sensor body, at least one measurement element disposed in the orifice and extends to the external wall of the sensor body, and a crimping means adjacent the sensor body for firmly clamping the at least one measurement element in the sensor body.

11. The apparatus as claimed in claim 10, wherein an equalizing line is arranged in the crimping means such that the measurement element projects from the equalizing line into the sensor body.

12. The apparatus as claimed in claim 11, wherein the equalizing line has external insulation.

13. The apparatus as claimed in claim 11, wherein an extraction thread is adjacent to the crimping means.

14. A method for producing an apparatus for the measurement of the temperature of a mold wall of an injection mold wherein the apparatus comprises a sensor body having an orifice which terminates at an external wall of the sensor body and at least one measurement element disposed in the orifice and which extends to the external wall of the sensor body comprising the step of reducing the cross section of the orifice for firmly clamping the measurement element in the sensor body.

15. A method for producing an apparatus for the measurement of the temperature of a mold wall of an injection mold wherein the apparatus comprises a sensor body having an orifice which terminates at an external wall of the sensor body and at least one measurement element disposed in the orifice and which extends to the external wall of the sensor body comprising the step of
providing a crimping sleeve with an equalizing line adjacent to the sensor body wherein the at least one measurement element passes through a passage in the crimpling sleeve, at least partially reducing an internal area of the passage in the crimping sleeve for fixing the equalizing line and the at least one measurement element.

16. A method for producing an apparatus for the measurement of the temperature of a mold wall of an injection mold wherein the apparatus comprises a sensor body having an orifice which terminates at an external wall of the sensor body and at least one measurement element disposed in the orifice and which extends to the external wall of the sensor body comprising the step of
grinding off any portion of the at least one measurement element which extends beyond the external wall of the sensor body.

17. A method for producing an apparatus for the measurement of the temperature of a mold wall of an injection mold wherein the apparatus comprises a sensor body having an orifice which terminates at an external wall of the sensor body and at least one measurement element disposed in the orifice and which extends to the external wall of the sensor body comprising the step of
coating any portion of the at least one measurement element which extends beyond the external wall of the sensor body with a weld or solder droplet and thereafter grinding off the portion.
